(19) United States
(12) Patent Application Publication
(10) Pub. No.: US 2015/0336587 A1
(43) Pub. Date: Nov. 26, 2015

(54) DRIVING ASSIST DEVICE

(71) Applicants: TOYOTA JIDOSHA KABUSHIKI KAISHA, Toyota-shi (JP); THE UNIVERSITY OF TOKYO, Tokyo (JP); National University Corporation Tokyo University of Agriculture and Technology, Tokyo (JP)

(72) Inventors: Hideo INOUE, Ashigarakami-gun (JP); Shintaro INOUE, Naka-gun (JP); Masahiro MIO, Fuji-shi (JP); Shingo SAKAIDA, Susono-shi (JP); Tsukasa SHIMIZU, Nagakute-shi (JP); Masayuki OKUWA, Nagakute-shi (JP); Minoru KAMATA, Tokyo (JP); Takuma ITO, Tokyo (JP); Pongsathorn RAKSINCHAROENSAK, Tokyo (JP); Masao NAGAI, Tokyo (JP)

(73) Assignees: TOYOTA JIDOSHA KABUSHIKI KAISHA, Toyota-shi (JP); THE UNIVERSITY OF TOKYO, Tokyo (JP); National University Corporation Tokyo University of Agriculture and Technology, Tokyo (JP)

(21) Appl. No.: 14/714,900

(22) Filed: May 18, 2015

(30) Foreign Application Priority Data
May 20, 2014 (JP) 2014-104600

(51) Int. Cl. B60W 50/08; B62D 6/00

(52) U.S. Cl. CPC B60W 50/087; B62D 6/00

(57) ABSTRACT

A driving assist device 1 includes: an information acquisition unit 20 that detects a driving operation of a driver for the vehicle; a driving skill evaluation unit 24 that evaluates a driving skill of the driver on the basis of a history of the driving operation of the driver; and a driving assist control unit 28 that performs the driving assist control for the vehicle on the basis of the traveling state of the vehicle and the target traveling state. When the information acquisition unit 20 detects the driving operation of the driver during the driving assist control, the driving assist control unit 28 limits the amount of driving assist control for the vehicle according to the driving skill of the driver evaluated and reflects the driving operation amount of the driver in traveling control for the vehicle.

### BACKGROUND OF THE INVENTION

1. Field of the Invention

The present invention relates to a driving assist device which assists the driving of the driver of a vehicle.

2. Related Background Art

As technical literature related to a driving assist device, Japanese Unexamined Patent Application Publication No. 2003-099897 has been published. Japanese Unexamined Patent Application Publication No. 2003-099897 discloses a curve traveling assist device which determines the driving skill of a driver on the basis of the curve state of a traveling lane, the content of a driving operation of the driver when the vehicle travels around a curve, and the moving state of the vehicle when the vehicle travels around the curve and determines the content of assist control according to the driving skill. Specifically, for example, in a case in which it is determined that the speed of the vehicle is too high before the vehicle enters a curve, when the driver is determined to be an experienced driver, the curve traveling assist device performs only a process of outputting a warning sound. When the driver is determined to be an inexperienced driver, the curve traveling assist device outputs the warning sound and automatically controls the vehicle.

### SUMMARY

However, in recent years, a study on the cooperation between the driving operation of the driver and driving assist control has been conducted in order to perform driving assist without giving the driver a feeling of discomfort. The above-mentioned curve traveling assist device determines the content of assist control, such as whether to perform automatic control, according to the driving skill of the driver. However, the curve traveling assist device does not consider a case in which the driver performs a driving operation during driving assist control such as automatic control. Therefore, it is necessary to improve the cooperation between the driving operation of the driver and the driving assist control.

Accordingly, in this technical field, there is a demand for a driving assist device which can perform driving assist control that cooperates with the driving operation of the driver according to the driving skill of the driver.

In order to solve the above-mentioned problems, according to an aspect of the invention, there is provided a driving assist device configured to calculate a target traveling state of a vehicle on the basis of a traveling environment of the vehicle and performs driving assist control for the vehicle such that the traveling state of the vehicle is close to the target traveling state. The driving assist device includes: a driving operation detection unit configured to detect a driving operation of a driver for the vehicle; a driving skill evaluation unit configured to evaluate a driving skill of the driver on the basis of a history of the driving operation of the driver detected by the driving operation detection unit; and a driving assist control unit configured to perform the driving assist control for the vehicle on the basis of the traveling state of the vehicle and the target traveling state. When the driving operation detection unit detects the driving operation of the driver during the driving assist control, the driving assist control unit limits the amount of driving assist control for the vehicle according to the driving skill of the driver evaluated by the driving skill evaluation unit and reflects the driving operation amount of the driver in traveling control for the vehicle.

According to the above-mentioned aspect, when the driving operation of the driver is detected during the driving assist control, the driving assist device limits the amount of driving assist control according to the driving skill of the driver and reflects the driving operation amount of the driver in traveling control for the vehicle. Therefore, it is possible to perform driving assist control which cooperates with the driving operation of the driver according to the driving skill of the driver. That is, when the driving operation of the driver is detected during the driving assist control, the driving assist device limits the amount of driving assist control according to the driving skill of the driver. Therefore, for example, when the driving skill level of the driver is high (for example, the driver is an experienced driver), the driving assist device can increase limitations on the amount of driving assist control such that the driver mainly controls the driving of the vehicle. When the driving skill level of the driver is low (for example, the driver is an inexperienced driver), the driving assist device can decrease limitations on the amount of driving assist control to perform sufficient driving assist control. The limitations on the amount of driving assist control also include limiting the amount of driving assist control to zero.

In the driving assist device according to the above-mentioned aspect, the driving skill evaluation unit may evaluate the driving skill of the driver on the basis of a history of a steering operation of the driver in a traveling section in which the vehicle has traveled and a reference steering operation corresponding to the shape of a road in the traveling section.

According to the driving assist device, the history of the steering operation of the driver in the traveling section, such as a curve, is compared with a reference steering operation corresponding to the shape of the road in the traveling section (for example, the steering state of an experienced driver which is calculated according to the curvature of the curve in the traveling section), which makes it possible to easily evaluate the driving skill of the driver.

In the driving assist device according to the above-mentioned aspect, the driving assist control may include steering assist control for the vehicle. The driving assist control unit may perform the steering assist control for the vehicle, using an assist motor that controls the steering torque of the vehicle and a torque vectoring mechanism that controls the distribution of a driving force transmitted to a pair of left and right wheels of the vehicle.

According to the driving assist device, the steering assist control for the vehicle is performed using both the assist motor that controls the steering torque of the vehicle and the torque vectoring mechanism. Therefore, it is possible to reduce the load of the assist motor.

As described above, according to the driving assist device of an aspect of the invention, it is possible to perform driving assist control which cooperates with the driving operation of the driver according to the driving skill of the driver.

### BRIEF DESCRIPTION OF THE DRAWINGS

FIG. 1 is a block diagram illustrating a driving assist device according to a first embodiment;

FIG. 2 is a flowchart illustrating control related to the calculation of a weight coefficient w;

FIG. 3 is a block diagram illustrating the control related to the calculation of the weight coefficient w;

FIG. 4 is a flowchart illustrating driving assist control;

FIG. 5 is a block diagram illustrating driving assist control when a driving operation of a driver is detected;

FIG. 6A is a graph illustrating a change in input steering torque over time when obstacle avoidance is performed using only a machine input;

FIG. 6B is a graph illustrating a change in input steering torque over time when obstacle avoidance is performed using only the input of the driver;

FIG. 6C is a graph illustrating a change in input steering torque over time when obstacle avoidance is performed by cooperation;

FIG. 7 is a block diagram illustrating a modification of the control related to the calculation of the weight coefficient w;

FIG. 8 is a block diagram illustrating an example of the calculation of a target traveling state and a machine input amount;

FIG. 9 is a block diagram illustrating a driving assist device according to a second embodiment;

FIG. 10 is a diagram illustrating the structure of a vehicle including a torque vectoring mechanism;

FIG. 11 is a block diagram illustrating control related to the torque vectoring mechanism; and

FIG. 12 is a graph illustrating a reduction in the load of an assist motor.

### DESCRIPTION OF THE PREFERRED EMBODIMENTS

Hereinafter, embodiments of the invention will be described with reference to the drawings. In the drawings, the same or equivalent components are denoted by the same reference numerals and the description thereof will not be repeated.

### First Embodiment

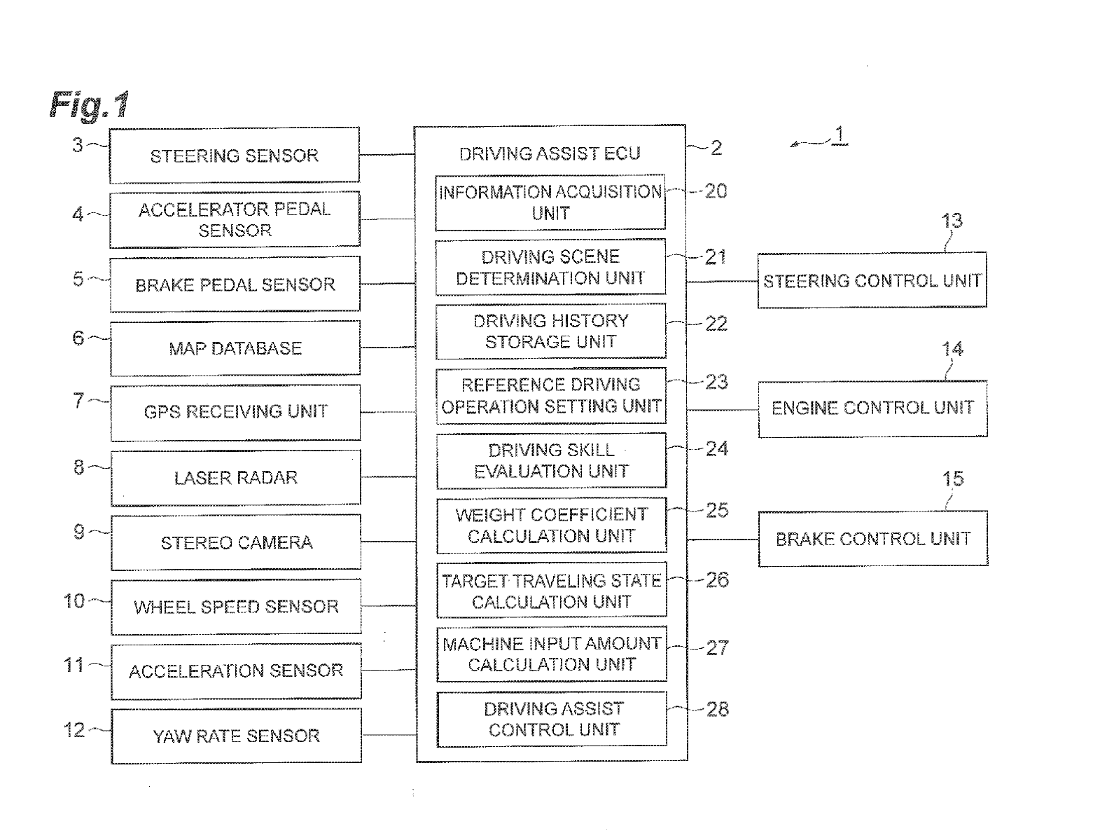

FIG. 1 is a block diagram illustrating a driving assist device according to a first embodiment. A driving assist device 1 illustrated in FIG. 1 is provided in a vehicle, such as a car, and performs driving assist control for assisting the driver to drive the vehicle. The driving assist control includes various control processes for controlling the traveling of the vehicle in order to assist the driver to drive the vehicle. The driving assist control includes steering assist control for assisting the steering operation of the driver and acceleration assist control for assisting the accelerator and brake operations of the driver.

Specifically, the driving assist control includes, for example, lane keeping assist for assisting the steering of the vehicle along a traveling lane, speed management for assisting speed adjustment before the vehicle enters an intersection or a curve, adaptive cruise control (ACC) for adjusting the distance between the vehicle and a vehicle in front, lane change assist for assisting a lane change to an adjacent lane, obstacle avoidance assist for avoiding a collision with obstacles, such as other vehicles, and intelligent parking assist (IPA) for assisting steering when the vehicle is parked.

The driving assist device 1 calculates a target traveling state of the vehicle on the basis of the traveling environment of the vehicle and performs driving assist control such that the traveling state of the vehicle is close to the target traveling state. The traveling environment of the vehicle means the shape of the road in the traveling lane along which the vehicle is traveling, the position of a white line in the traveling lane, the situation of other vehicles around the vehicle, weather, such as rainy weather, the distinction between day and night, and various other environments which affect the traveling of the vehicle. The target traveling state means the traveling state of the vehicle to be subjected to driving assist control in the traveling environment of the vehicle. For example, in the lane keeping assist, the traveling state of the vehicle which travels along the center of the traveling lane is the target traveling state. In the lane keeping assist, the driving assist device 1 performs a control process of assisting the steering of the vehicle such that the traveling state of the vehicle is close to a traveling state in which the vehicle travels along the center of the traveling lane.

The driving assist device 1 evaluates the driving skill of the driver on the basis of the history of the driving operation of the driver. The driving operation is, for example, the operation of the steering wheel by the vehicle, the depression of an accelerator pedal, and the depression of a brake pedal. The driving assist device 1 evaluates the driving skill of the driver on the basis of the history of the driving operation of the driver in a traveling section, such as a curve, and a reference driving operation corresponding to the shape of the road in the traveling section. The reference driving operation is, for example, a standard driving operation (for example, a steering operation, an accelerator operation, and a brake operation) that is calculated according to the curvature of a curve which is the traveling section. The reference driving operation is not necessarily calculated by computation. For example, a reference driver model which is stored in advance according to the shape of the road may be used as the reference driving operation.

When the driving operation of the driver is detected during driving assist control, the driving assist device 1 limits the amount of driving assist control for the vehicle according to the driving skill of the driver and reflects the driving operation amount of the driver in traveling control for the vehicle. The amount of driving assist control is, for example, the magnitude of steering torque which is applied to the vehicle in the lane keeping assist, the magnitude of driving force which is applied to the vehicle in the ACC, or the magnitude of braking force. The driving operation amount of the driver is, for example, steering torque which is applied to the steering wheel, the amount of depression of the accelerator pedal, or the amount of depression of the brake pedal. Since the driving assist device 1 limits the amount of driving assist control and reflects the driving operation amount of the driver in traveling control for the vehicle, it is possible to perform driving assist control which cooperates with the driving operation of the driver, according to the driving skill of the driver.

<Structure of Driving Assist Device>

Hereinafter, the structure of the driving assist device 1 will be described with reference to FIG. 1. As illustrated in FIG. 1, the driving assist device 1 includes a driving assist electronic control unit (ECU) 2 which performs driving assist control for the vehicle. The driving assist ECU 2 is an electronic control unit including, for example, a central processing unit (CPU), a read only memory (ROM), and a random access memory (RAM). The driving assist ECU 2 loads a program stored in the ROM to the RAM and the CPU executes the program to perform various types of driving assist control.

The driving assist ECU 2 is connected to a steering sensor 3, an accelerator pedal sensor 4, a brake pedal sensor 5, a map database 6, a GPS receiving unit 7, a laser radar 8, a stereo camera 9, a wheel speed sensor 10, an acceleration sensor 11, and a yaw rate sensor 12. In addition, the driving assist ECU 2 is connected to a steering control unit 13, an engine control unit 14, and a brake control unit 15.

The steering sensor 3 is provided in, for example, a steering shaft of the vehicle and detects the steering torque of the steering wheel.

The steering sensor 3 may detect the steering angle of the steering wheel. The steering sensor 3 outputs a signal corresponding to the detected steering torque or steering angle to the driving assist ECU 2.

The accelerator pedal sensor 4 is provided in, for example, a shaft portion of the accelerator pedal and detects the amount of depression of the accelerator pedal (the position of the accelerator pedal). The accelerator pedal sensor 4 outputs a signal corresponding to the detected amount of depression of the accelerator pedal to the driving assist ECU 2. Similarly, the brake pedal sensor 5 is provided in, for example, a shaft portion of the brake pedal and detects the amount of depression of the brake pedal (the position of the brake pedal). The brake pedal sensor 5 may detect the amount of depression of the brake pedal from the operating force of the brake pedal (for example, force on the brake pedal or the pressure of a master cylinder). The brake pedal sensor 5 outputs a signal corresponding to the detected amount of depression of the brake pedal or the detected operating force to the driving assist ECU 2.

The map database 6 is, for example, a database which is stored in a hard disk drive provided in the vehicle and stores map information. The map information includes, for example, various kinds of building location information, road location information, information about the type of road, and intersection location information. In addition, the map information includes information about the shape of the road (for example, information about the curvature of a curve) which is associated with the road location information.

The GPS receiving unit 7 receives signals from, for example, three or more GPS satellites and detects (measures) the position (for example, latitude and longitude) of the vehicle. The GPS receiving unit 7 outputs a signal corresponding to the detected position of the vehicle to the driving assist ECU 2. The map database 6 and the GPS receiving unit 7 may form a portion of a navigation system for guiding the driver of the vehicle.

The laser radar 8 is provided at, for example, the leading end of the vehicle and detects obstacles in front of the vehicle using laser waves. For example, the laser radar 8 transmits laser waves in front of the vehicle, receives laser waves reflected from obstacles, such as other vehicles, and detects the obstacles. The laser radar 8 outputs a signal corresponding to the detected obstacles to the driving assist ECU 2. In addition, for example, a millimeter-wave radar may be used as the laser radar 8.

The stereo camera 9 includes, for example, two imaging units which are provided on the rear surface of the front windshield of the vehicle and captures the image of the front side of the vehicle using the imaging units. The stereo camera 9 outputs a signal corresponding to the captured image to the driving assist ECU 2. In addition, a monocular camera may be used instead of the stereo camera 9.

The wheel speed sensor 10 is provided in a portion which is rotated integrally with the wheel, such as a drive shaft or an axle hub, and detects the rotation speed of the wheel. The wheel speed sensor 10 outputs a signal corresponding to the detected rotation speed of the wheel to the driving assist ECU 2.

The acceleration sensor 11 detects the acceleration (deceleration) of the vehicle. The acceleration sensor 11 includes, for example, a longitudinal acceleration sensor which detects the longitudinal acceleration of the vehicle and a lateral acceleration sensor which detects the lateral acceleration of the vehicle. The acceleration sensor 11 outputs a signal corresponding to the detected acceleration of the vehicle to the driving assist ECU 2. The yaw rate sensor 12 detects the yaw rate (angular velocity) of the center of gravity of the vehicle about the vertical axis. For example, a gyro sensor can be used as the yaw rate sensor 12. The yaw rate sensor 12 outputs a signal corresponding to the detected yaw rate of the vehicle to the driving assist ECU 2.

The steering control unit 13 is an electronic unit which controls the steering system of the vehicle. The steering control unit 13 controls an electric power steering system (EPS). The steering control unit 13 drives an assist motor for controlling the steering torque of the vehicle to control the steering torque of the vehicle. The steering control unit 13 controls the steering system in response to a control signal from the driving assist ECU 2.

The engine control unit 14 is an electronic unit which controls the engine of the vehicle. The engine control unit 14 controls, for example, the amount of fuel and air supplied to the engine to control the driving force of the vehicle. When the vehicle is a hybrid vehicle or an electric vehicle, the engine control unit 14 controls a motor which operates as a power source. The engine control unit 14 controls the driving force of the vehicle in response to a control signal from the driving assist ECU 2.

The brake control unit 15 is an electronic unit which controls the brake system of the vehicle. For example, a hydraulic brake system can be used as the brake system of the vehicle. The brake control unit 15 adjusts hydraulic pressure applied to the hydraulic brake system to control braking force applied to the wheels. The brake control unit 15 controls the braking force applied to the wheels in response to a control signal from the driving assist ECU 2. When the vehicle includes a regenerative brake system, the brake control unit 15 may control both the hydraulic brake system and the regenerative brake system.

Next, the functional structure of the driving assist ECU 2 will be described. The driving assist ECU 2 includes an information acquisition unit 20, a driving scene determination unit 21, a driving history storage unit 22, a reference driving operation setting unit 23, a driving skill evaluation unit 24, a weight coefficient calculation unit 25, a target traveling state calculation unit 26, a machine input amount calculation unit 27, and a driving assist control unit 28.

The information acquisition unit 20 acquires information required to evaluate the driving skill of the driver and information required for driving assist control. Specifically, the information acquisition unit 20 acquires the steering information of the driver on the basis of the signal from the steering sensor 3. The information acquisition unit 20 acquires the accelerator operation information of the driver on the basis of the signal from the accelerator pedal sensor 4 and acquires the brake operation information of the driver on the basis of the signal from the brake pedal sensor 5.

In addition, the information acquisition unit 20 acquires the positional information of the vehicle on the basis of the signal from the GPS receiving unit 7 and acquires map information for the surroundings of the vehicle with reference to the map database 6. The information acquisition unit 20 recognizes the road on which the vehicle is traveling and the shape of the road, on the basis of the acquired positional information of the vehicle and the acquired map information. In addition, the information acquisition unit 20 acquires information about obstacles around the vehicle on the basis of the signals from the laser radar 8 and the stereo camera 9. The information acquisition unit 20 acquires the positional information of the white line of the traveling lane on the basis of the signal from the stereo camera 9. The information acquisition unit 20 recognizes the traveling environment of the vehicle on the basis of, for example, the positional information of the vehicle, the map information, the obstacle information, and the positional information of the white line of the traveling lane. The information acquisition unit 20 may acquire rainy weather information from whether the wipers of the vehicle are operating or not, or it may acquire day and night information from whether the headlights are turned on or off.

The information acquisition unit 20 acquires the speed information of the vehicle on the basis of the signal from the wheel speed sensor 10 and acquires the acceleration information (longitudinal acceleration information and lateral acceleration information) of the vehicle on the basis of the signal from the acceleration sensor 11. The information acquisition unit 20 acquires the yaw rate infonnation of the vehicle on the basis of the signal from the yaw rate sensor 12. The information acquisition unit 20 recognizes the traveling state of the vehicle on the basis of the speed information, acceleration information, and yaw rate information of the vehicle.

The information acquisition unit 20 functions as a driving operation detection unit which detects the driving operation of the driver for the vehicle, on the basis of the steering information, accelerator operation information, and brake operation information of the driver. The information acquisition unit 20 detects the driving operation of the driver, for example, when steering torque which is input to the steering wheel by the driver is equal to or greater than a predetermined steering detection threshold value, on the basis of the steering information. In addition, the information acquisition unit 20 may detect the driving operation of the driver when the period for which the steering torque which is input to the steering wheel by the driver is equal to or greater than the steering detection threshold value is greater than a predetermined duration threshold value. The predetermined steering detection threshold value and the predetermined duration threshold value are appropriately set in order to detect the driver's clear intention to drive the vehicle. Similarly, the information acquisition unit 20 can detect the driving operation of the driver on the basis of the accelerator operation information and the brake operation information. In addition, the information acquisition unit 20 may acquire various kinds of information including so-called big data through road-to-vehicle communication or vehicle-to-vehicle communication.

The driving scene determination unit 21 determines whether a vehicle driving scene is a normal scene. The driving scene means the traveling state of the vehicle and is classified by, for example, the shape of the road on which the vehicle is traveling (for example, the shape of a straight road or a curve), the state of other vehicles around the vehicle, and the traveling state of the vehicle (for example, a state in which the vehicle changes the lane or a state in which the vehicle turns left or right at an intersection). The normal scene is a scene which is suitable to evaluate the driving skill of the driver among the driving scenes. The normal scene can be, for example, a scene in which the vehicle travels along a straight road or a curve and there are no other vehicles around the vehicle. The driving scene determination unit 21 determines whether the vehicle driving scene is the normal scene on the basis of, for example, the traveling environment of the vehicle (the shape of the road in the traveling lane) recognized by the information acquisition unit 20 and the obstacle information acquired by the information acquisition unit 20.

The driving scene determination unit 21 sets a traveling section (for example, a straight road section or a curve section) corresponding to the shape of the road on which the vehicle has traveled and determines the driving scene for each traveling section. The traveling sections may be divided according to the shape of the road and a predetermined distance (for example, 50 m). In addition, the driving scene determination unit 21 may not determine the current vehicle driving scene, but may determine the past vehicle driving scene on the basis of the past traveling environment and driving operation information of the vehicle (for example, information corresponding to one day).

The driving history storage unit 22 stores the history of the driving operation of the driver of the vehicle recognized by the information acquisition unit 20. For example, the driving history storage unit 22 stores the history of the driving operation in the traveling section which is determined to be the normal scene by the driving scene determination unit 21 as the history of the driving operation for evaluating the driving skill. When the vehicle has a function of authenticating each driver, the driving history storage unit 22 stores the history of the driving operation of each driver on the basis of the personal authentication information of the driver.

The reference driving operation setting unit 23 sets a reference driving operation for each traveling section on the basis of the shape of the road in the traveling section (for example, the curvature of the curve section) which is determined to be the normal scene by the driving scene determination unit 21. The reference driving operation means a driving operation which is a standard for evaluating the driving skill of the driver. The reference driving operation includes at least one of a reference steering (standard steering) operation and reference accelerator and brake operations (reference acceleration and deceleration operation). For example, the reference driving operation setting unit 23 sets a reference driver model which is stored in advance according to the shape of the road in the traveling section as the reference driving operation. The reference driver model is obtained by statistically modeling (for example, averaging) the driving operation information of experienced drivers obtained from a plurality of vehicles. The reference driver model is determined for, for example, the shape of the road in each traveling section. An experienced driver can be defined in various ways. An experienced driver may be a driver with a driving skill level greater than a predetermined threshold value, which is evaluated by the driving skill evaluation unit 24 that will be described below. In addition, a reference driver model obtained by statistically modeling the acquired driving operation information of a plurality of drivers, without distinguishing experienced drivers, may be used.

Alternatively, the reference driving operation setting unit 23 may set the reference driving operation which is calculated on the basis of the shape of the road in the traveling section to the traveling section. The reference driving operation setting unit 23 may calculate a target path along which the vehicle will travel, on the basis of, for example, the shape of the road in the traveling section and may set a steering operation of driving the vehicle along the target path as the reference steering operation. Similarly, the reference driving operation setting unit 23 may calculate the target speed pattern of the vehicle on the basis of, for example, the shape of the road in the traveling section and may set vehicle accelerator and brake operations according to the target speed pattern as the reference acceleration and deceleration operation. For example, a known method according to the related art can be used to calculate the target path and the target speed pattern.

The reference driving operation setting unit 23 may set an appropriate reference driving operation on the basis of, for example, weather, such as rainy weather, and the distinction between day and night, in addition to the shape of the road. For example, when the weather is rainy or snowy, the reference driving operation setting unit 23 can reduce a change in the steering torque in the reference steering operation, which is the reference driving operation, as compared to when the weather is sunny.

The driving skill evaluation unit 24 evaluates the driving skill of the driver on the basis of the history of the driving operation for evaluating the driving skill which is stored in the driving history storage unit 22. The driving skill evaluation unit 24 compares the history of the driving operation of the driver in the traveling section with the reference driving operation in the traveling section to evaluate the driving skill of the driver.

The driving skill evaluation unit 24 evaluates the driving skill of the driver on the basis of, for example, the history of the steering operation of the driver in the traveling section and the reference steering operation in the traveling section which is set by the reference driving operation setting unit 23. The driving skill evaluation unit 24 may evaluate the driving skill of the driver on the basis of the difference between the amount of steering of the driver and the amount of steering in the reference steering operation. The driving skill evaluation unit 24 evaluates that the driving skill level of the driver decreases as the difference between the amount of steering of the driver and the amount of steering in the reference steering operation increases. The driving skill evaluation unit 24 evaluates that the driving skill level of the driver increases as the difference between the amount of steering of the driver and the amount of steering in the reference steering operation decreases. In addition, the driving skill evaluation unit 24 may evaluate the driving skill of the driver on the basis of the delay of a change in the amount of steering of the driver over time with respect to a change in the amount of steering in the reference steering operation over time.

Similarly, the driving skill evaluation unit 24 may evaluate the driving skill of the driver on the basis of the history of the accelerator and brake operations of the driver in the traveling section and the reference acceleration and deceleration operation in the traveling section. For example, the driving skill evaluation unit 24 evaluates the driving skill of the driver on the basis of the accelerator operation amount of the driver and the accelerator operation amount in the reference acceleration and deceleration operation. The driving skill evaluation unit 24 may evaluate the driving skill of the driver on the basis of the delay of a change in the accelerator operation amount of the driver over time with respect to a change in the accelerator operation amount in the reference acceleration and deceleration operation. This holds for the brake operation.

For example, the driving skill evaluation unit 24 evaluates the driving skill of the driver every three days on the basis of the history of the driving operation from the previous evaluation process to the current evaluation process and the reference acceleration and deceleration operation. The driving skill evaluation unit 24 may indicate the driving skill of the driver as an evaluation point. In addition, the driving skill evaluation unit 24 may evaluate the driving skill of the driver on the basis of the history of the driving operation of the driver, without a comparison with the reference driving operation. The driving skill evaluation unit 24 may evaluate the driving skill of the driver from, for example, the smoothness of a change in the driving operation and the number of sudden braking operations, on the basis of the history of the driving operation of the driver. In addition, when the evaluation of the driving skill of the driver is improved, the driving skill evaluation unit 24 notifies the driver of the improvement using, for example, a sound or a display.

The weight coefficient calculation unit 25 calculates a weight coefficient w on the basis of the driving skill of the driver evaluated by the driving skill evaluation unit 24. The weight coefficient w indicates the degree of cooperation of the driving assist control when the driving operation of the driver is detected. In other words, the weight coefficient w indicates the degree of limitation on the amount of driving assist control when a case in which the driving operation of the driver is detected is compared with a case in which the driving operation of the driver is not detected. As the weight coefficient w decreases, the amount of driving assist control increases. As the weight coefficient w increases, the amount of driving assist control decreases. The weight coefficient w is, for example, equal to or greater than 0 and less than 1. When the weight coefficient w is 0 (zero), the amount of driving assist control is limited to 0. The weight coefficient calculation unit 25 calculates the weight coefficient w which decreases as the driving skill level of the driver evaluated by the driving skill evaluation unit 24 increases. The weight coefficient calculation unit 25 calculates the weight coefficient w which increases as the driving skill level of the driver evaluated by the driving skill evaluation unit 24 decreases.

The weight coefficient calculation unit 25 may calculate the weight coefficient w on the basis of various kinds of information (so-called big data) other than the driving skill of the driver. For example, the weight coefficient calculation unit 25 may calculate the weight coefficient w such that, when it is fine, the weight coefficient w is greater than that when it rains or snows. For example, the weight coefficient calculation unit 25 may calculate the weight coefficient w such that the weight coefficient w during the night is greater than that during the day. In addition, the weight coefficient calculation unit 25 may calculate the weight coefficient w on the basis of physical condition information of the driver. For example, the driver can input his or her physical condition information to the device and the device can acquire the physical condition information of the driver. In addition, the physical condition information input to the device may be acquired from image information captured by a driver camera which is provided in the vehicle. For example, the weight coefficient calculation unit 25 may calculate the weight coefficient w, such that, when it is determined that the driver is lacking sleep on the basis of the eye blink frequency of the driver which is calculated from the image information captured by the driver camera, the weight coefficient w is greater than that when it is determined that the driver is in a normal state.

The target traveling state calculation unit 26 calculates the target traveling state of the vehicle on the basis of the traveling environment of the vehicle recognized by the information acquisition unit 20. The target traveling state calculation unit 26 may calculate the target traveling state of the vehicle, using the traveling state of the vehicle and the map information, in addition to the traveling environment of the vehicle. The target traveling state calculation unit 26 calculates the target traveling state of the vehicle corresponding to the content of the driving assist control. For example, the target traveling state calculation unit 26 calculates a state in which the vehicle travels along the center of the traveling lane as the target traveling state in the lane keeping assist. For example, the target traveling state calculation unit 26 calculates a state in which the vehicle is decelerated to a predetermined target vehicle speed at the entrance of a curve (for example, a target vehicle speed which is set according to the curvature of the curve) in the speed management that assists the adjustment of the speed before the vehicle enters a curve. For example, a known method according to the related art can be used to calculate the target traveling state.

The machine input amount calculation unit 27 calculates a machine input amount on the basis of the target traveling state calculated by the target traveling state calculation unit 26 and the traveling state of the vehicle recognized by the information acquisition unit 20. The machine input amount is a driving operation amount which is input to the vehicle by the driving assist device 1 such that the traveling state is close to the target traveling state. The machine input amount includes at least one of machine input steering torque, a machine input accelerator operation amount, and a machine input brake operation amount. For example, the machine input amount calculation unit 27 calculates the machine input amount such that the traveling state of the vehicle is identical to the target traveling state, using only the machine input amount, without the input of the driver's driving operation.

For example, the machine input amount calculation unit 27 calculates the machine input steering torque such that the traveling state of the vehicle is identical to the target traveling state in which the vehicle travels along the center of the traveling lane in the lane keeping assist. For example, the machine input amount calculation unit 27 calculates the machine input brake operation amount such that the vehicle is brought into the target traveling state in which the vehicle is decelerated to a predetermined target vehicle speed at the entrance of the curve in the speed management that assists the adjustment of the speed before the vehicle enters the curve. For example, a known method according to the related art can be used to calculate the machine input amount.

The driving assist control unit 28 performs driving assist control for the vehicle on the basis of the machine input amount calculated by the machine input amount calculation unit 27. The driving assist control unit 28 receives a driving assist control start input (for example, a lane keeping assist start input or a lane change assist start input) from the user and starts each driving assist control process. In addition, for example, when a predetermined driving assist control start condition is satisfied, the driving assist control unit 28 starts the driving assist control. The driving assist control unit 28 starts an obstacle avoidance assist process, for example, when the time-to-collision (TTC) between the vehicle and the obstacle is equal to or less than a predetermined threshold value.

When the driving operation of the driver is not detected by the information acquisition unit 20, the driving assist control unit 28 reflects the machine input amount calculated by the machine input amount calculation unit 27 in traveling control for the vehicle. The driving assist control unit 28 outputs control signals to at least one of the steering control unit 13, the engine control unit 14, and the brake control unit 15 on the basis of the machine input amount to reflect the machine input amount in traveling control for the vehicle. When the machine input amount includes only the machine input steering torque, the driving assist control unit 28 outputs the control signal only to the steering control unit 13. The driving assist control unit 28 reflects the machine input amount in traveling control for the vehicle to perform driving assist control such that the traveling state of the vehicle is close to the target traveling state.

When the driving operation of the driver is detected by the information acquisition unit 20, the driving assist control unit 28 limits the amount of driving assist control for the vehicle according to the driving skill of the driver. When the driving operation of the driver is detected by the information acquisition unit 20, the driving assist control unit 28 reflects a limited machine input amount, which is obtained by multiplying the machine input amount by the weight coefficient w (which is equal to or greater than 0 and less than 1) calculated by the weight coefficient calculation unit 25, in traveling control for the vehicle. When the driving operation of the driver is detected by the information acquisition unit 20, the driving assist control unit 28 outputs control signals to at least one of the steering control unit 13, the engine control unit 14, and the brake control unit 15 on the basis of the limited machine input amount multiplied by the weight coefficient w to limit the amount of driving assist control, as compared to the case in which it is determined that the driving operation of the driver is not detected. In addition, when the weight coefficient w is 0, the limited machine input amount is also 0.

When the driving operation of the driver is detected by the information acquisition unit 20, the driving assist control unit 28 reflects the driving operation amount of the driver (for example, steering torque, an accelerator operation amount, and a brake operation amount) in traveling control for the vehicle. For example, the driving assist control unit 28 reflects the driving operation amount of the driver in traveling control for the vehicle, without limiting the driving operation amount. Specifically, the driving assist control unit 28 reflects a total input amount obtained by adding the limited machine input amount to the driving operation amount of the driver in traveling control for the vehicle. The driving assist control unit 28 outputs control signals to at least one of the steering control unit 13, the engine control unit 14, and the brake control unit 15 on the basis of the total input amount to assist the driving operation of the driver such that the traveling state of the vehicle is close to the target traveling state. When the driver performs a driving operation of causing the traveling state of the vehicle to depart from the target traveling state (when the driving operation amount of the driver is steering torque in the steering direction of a right turn and the limited machine input amount is steering torque in the steering direction of a left turn), the driving operation amount of the driver and the limited machine input amount cancel each other and the difference therebetween may be reflected as the total input amount in traveling control for the vehicle.

The structure of the driving assist device 1 has been described above. However, the structure of the driving assist device 1 is not limited to the above-mentioned structure. For example, at least one of the functions of the information acquisition unit 20, the driving scene determination unit 21, the driving history storage unit 22, the reference driving operation setting unit 23, the driving skill evaluation unit 24, and the weight coefficient calculation unit 25 may not be implemented by the driving assist ECU 2 provided in the vehicle, but may be implemented by a computer provided in, for example, an information management center that performs road-to-vehicle communication with the vehicle. For example, the vehicle may transmit the history of the driving operation of the driver and the history of the traveling state of the vehicle to the information management center, receive the information of the weight coefficient w calculated by the information management center, and use the received information for the driving assist control.

In addition, the driving assist control unit 28 does not necessarily limit the amount of driving assist control using the weight coefficient w. The driving assist control unit 28 may limit the amount of driving assist control according to the driving skill of the driver evaluated by the driving skill evaluation unit 24, without using the weight coefficient w. In this case, the driving assist control unit 28 increases limitations on the amount of driving assist control as the driving skill level of the driver increases. The driving assist control unit 28 decreases limitations on the amount of driving assist control as the driving skill level of the driver decreases.

<Control of Driving Assist Device>

Next, the control of the driving assist device 1 according to the first embodiment will be described. The control of the driving assist device 1 includes control related to the calculation of the weight coefficient w (control related to the evaluation of a driving technique) and driving assist control.

<<Control Related to Calculation of Weight Coefficient w>>

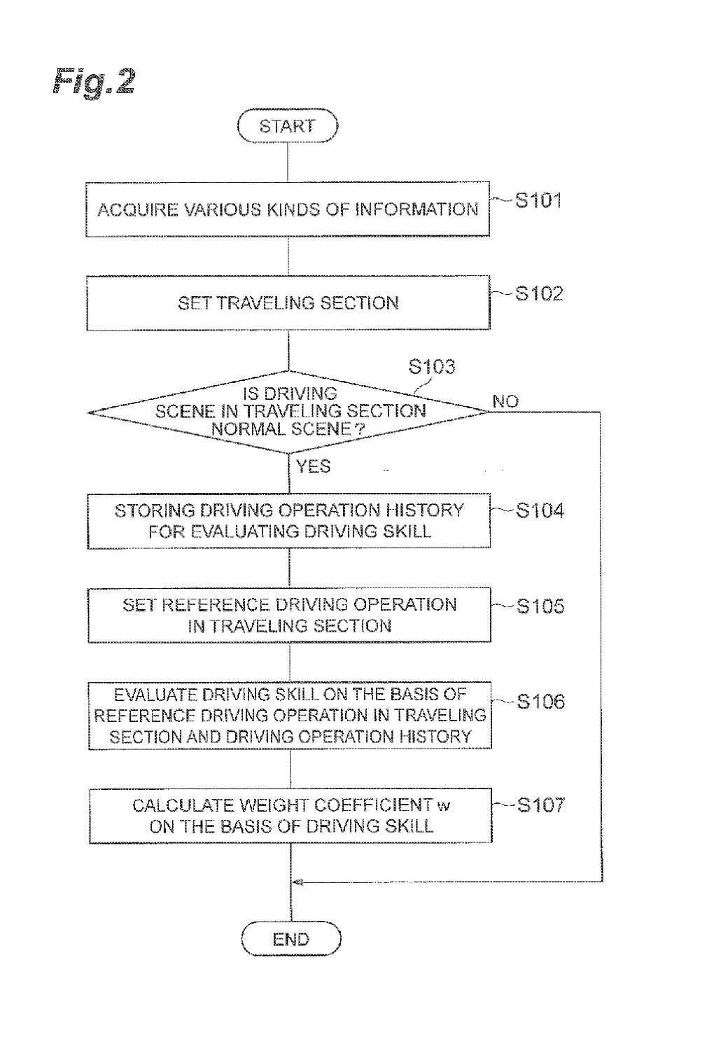

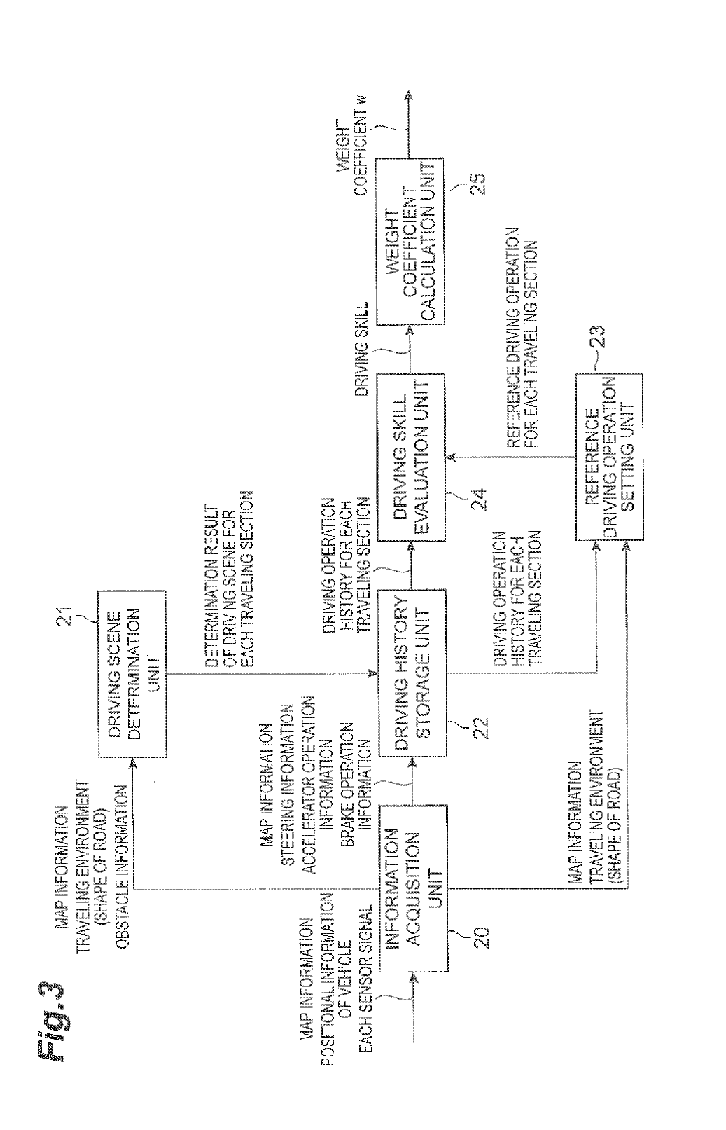

First, the control related to the calculation of the weight coefficient w will be described with reference to the drawings. FIG. 2 is a flowchart illustrating the control related to the calculation of the weight coefficient w. FIG. 3 is a block diagram illustrating the control related to the calculation of the weight coefficient w.

As illustrated in FIGS. 2 and 3, in Step S101, the information acquisition unit 20 of the driving assist device 1 acquires various kinds of information required to calculate the weight coefficient w. The information acquisition unit 20 recognizes the traveling environment of the vehicle and the traveling state of the vehicle on the basis of various kinds of information such as the acquired map information.

Then, in Step S102, the driving scene determination unit 21 sets the traveling section to the road on which the vehicle has traveled. The driving scene determination unit 21 sets the traveling section (for example, a straight road section or a curve section) according to, for example, the shape of the road on which the vehicle has traveled. The driving scene determination unit 21 may set a plurality of traveling sections at a time. The traveling sections do not need to be continuous, but may be set so as to be separated from each other.

Then, in Step S103, the driving scene determination unit 21 determines whether the driving scene of the vehicle in the traveling section is the normal scene. For example, the driving scene determination unit 21 determines whether the driving scene of the vehicle in the traveling section is the normal scene on the basis of the traveling environment of the vehicle recognized by the information acquisition unit 20 and the obstacle information acquired by the information acquisition unit 20. When it is determined that the driving scene of the vehicle in the traveling section is not the normal scene (S103: No), the driving scene determination unit 21 ends the control related to the calculation of the weight coefficient w. When it is determined that the driving scene of the vehicle in the traveling section is the normal scene (S103: yes), the driving scene determination unit 21 proceeds to Step S104. When it is determined that the driving scene of the vehicle in at least one of a plurality of traveling sections is the normal scene, the driving scene determination unit 21 proceeds to Step S104.

In Step S104, the driving history storage unit 22 stores the history of the driving operation in the traveling section which is determined to be the normal scene by the driving scene determination unit 21 as the history of the driving operation for evaluating the driving skill.

Then, in Step S105, the reference driving operation setting unit 23 sets the reference driving operation in the traveling section which is determined to be the normal scene by the driving scene determination unit 21. The reference driving operation setting unit 23 sets the reference driving operation to each traveling section on the basis of the shape of the road in the traveling section which is determined to be the normal scene by the driving scene determination unit 21.

Then, in Step S106, the driving skill evaluation unit 24 evaluates the driving skill of the driver on the basis of the history of the driving operation for evaluating the driving skill which is stored in the driving history storage unit 22. The driving skill evaluation unit 24 compares the history of the driving operation of the driver in the traveling section with the reference driving operation in the traveling section to evaluate the driving skill of the driver.

In Step S107, the weight coefficient calculation unit 25 calculates the weight coefficient w on the basis of the driving skill of the driver evaluated by the driving skill evaluation unit 24. The weight coefficient calculation unit 25 may calculate the weight coefficient w on the basis of various kinds of information, such as weather, in addition to the driving skill of the driver. The weight coefficient calculation unit 25 may calculate the weight coefficient w whenever the driving skill evaluation unit 24 updates the evaluation of the driving skill.

<<Driving Assist Control>>

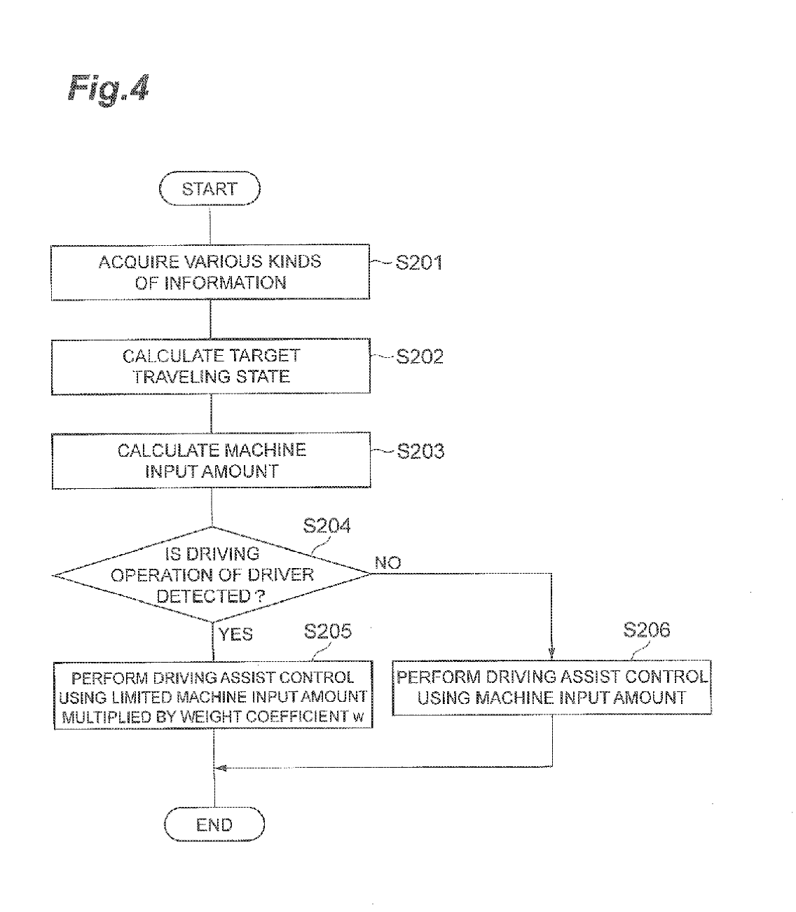

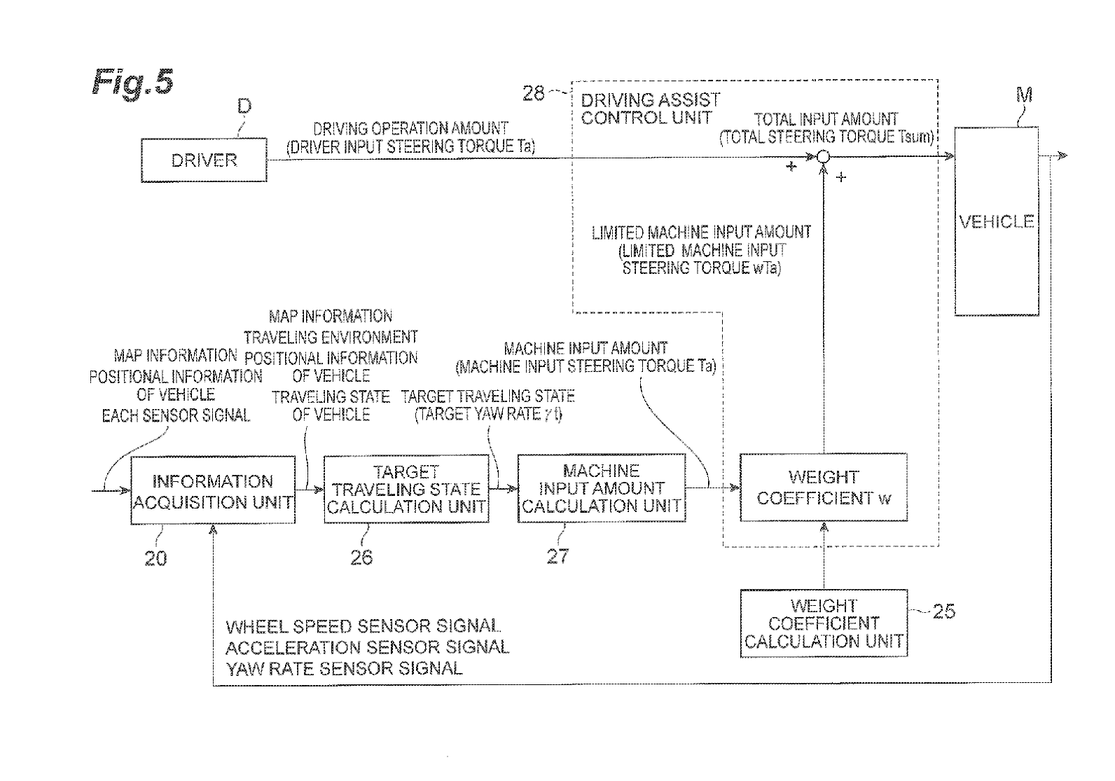

Next, the driving assist control will be described with reference to the drawings. FIG. 4 is a flowchart illustrating the driving assist control. FIG. 5 is a block diagram illustrating the driving assist control when the driving operation of the driver is detected.

As illustrated in FIGS. 4 and 5, when the driving assist control starts, the information acquisition unit 20 of the driving assist device 1 acquires various kinds of information required for the driving assist control in Step S201. The information acquisition unit 20 recognizes the traveling environment of a vehicle M and the traveling state of the vehicle. M on the basis of various kinds of information such as the acquired map information.

In Step S202, the target traveling state calculation unit 26 calculates the target traveling state which is a driving assist control target on the basis of the traveling environment of the vehicle M recognized by the information acquisition unit 20. The target traveling state calculation unit 26 may calculate the target traveling state of the vehicle M, using the traveling state of the vehicle M, the map information, and other information, in addition to the traveling environment of the vehicle M. For example, in the lane keeping assist, the target traveling state calculation unit 26 may calculate the target yaw rate γt of the vehicle M as the target traveling state of the vehicle M, on the basis of the traveling environment of the vehicle M (including the positional information of the white lines of the traveling lane) recognized by the information acquisition unit 20.

In Step S203, the machine input amount calculation unit 27 calculates the machine input amount which is the amount of driving assist control. The machine input amount calculation unit 27 calculates the machine input amount on the basis of the target traveling state calculated by the target traveling state calculation unit 26 and the traveling state of the vehicle M recognized by the information acquisition unit 20. For example, in the lane keeping assist, the machine input amount calculation unit 27 calculates machine input steering torque Ta required to change the traveling state of the vehicle M to the target yaw rate γt calculated by the target traveling state calculation unit 26.

In Step S204, the driving assist control unit 28 determines whether the driving operation of a driver D is detected by the information acquisition unit 20. The information acquisition unit 20 detects the driving operation of the driver D on the basis of the steering information, accelerator operation information, and brake operation information of the driver D. When the driving operation of the driver D is detected by the information acquisition unit 20 (S204: Yes), the driving assist control unit 28 proceeds to Step S205. When the driving operation of the driver D is not detected by the information acquisition unit 20 (S204: No), the driving assist control unit 28 proceeds to Step S206.

In Step S205, the driving assist control unit 28 limits the amount of driving assist control for the vehicle M according to the driving skill of the driver D and reflects the driving operation amount of the driver D in traveling control for the vehicle M. The driving assist control unit 28 reflects the limited machine input amount, which is obtained by multiplying the machine input amount calculated by the machine input amount calculation unit 27 by the weight coefficient w (which is equal to or greater than 0 and less than 1), in traveling control for the vehicle M. The driving assist control unit 28 reflects the total input amount obtained by adding the limited machine input amount to the driving operation amount of the driver D in traveling control for the vehicle M. For example, the driving assist control unit 28 reflects a total input steering torque Tsum, which is the sum of a limited machine input steering torque wTa obtained by multiplying a machine input steering torque Ta calculated by the machine input amount calculation unit 27 by the weight coefficient w and a driver input steering torque Td that is applied to the steering wheel of the vehicle M by the driver D, in traveling control for the vehicle M.

In Step S206, the driving assist control unit 28 reflects the machine input amount calculated by the machine input amount calculation unit 27 in traveling control for the vehicle M. When a predetermined control update time has elapsed from the start of Step S205 or Step S206, the driving assist device 1 repeats the process from Step S201 again. The predetermined control update time is, for example, the time corresponding to the clock frequency of the driving assist ECU 2. For example, when the driver D performs a driving assist cancellation operation, the driving assist device 1 ends the driving assist control. The driving assist cancellation operation is, for example, the operation of the driver D pressing a driving assist control cancellation button or the operation of the driver D stopping the engine of the vehicle M. When the driver D performs a driving operation (for example, a sudden braking operation or an override operation) which is beyond the allowable range of the driving assist control, the driving assist control may be cancelled.

<Operation and Effect of Driving Assist Device>

As described above, when the driving operation of the driver D is detected during driving assist control, the driving assist device 1 according to the first embodiment limits the amount of driving assist control according to the driving skill of the driver D and reflects the driving operation amount of the driver D in traveling control for the vehicle M. Therefore, it is possible to perform driving assist control which cooperates with the driving operation of the driver D according to the driving skill of the driver D. That is, when the driving operation of the driver D is detected during driving assist control, the driving assist device 1 limits the amount of driving assist control according to the driving skill of the driver D. For example, when the driver D has a high driving skill level (for example, when the driver is an experienced driver), the driving assist device 1 can significantly increase limitations on the amount of driving assist control such that the driver D mainly controls the driving of the vehicle M, as compared to when the driving operation of the driver D is not detected. When the driver D has a low driving skill level (for example, when the driver is an inexperienced driver), the driving assist device 1 can decrease limitations on the amount of driving assist control such that sufficient driving assist is performed, as compared to when the driving operation of the driver D is not detected.

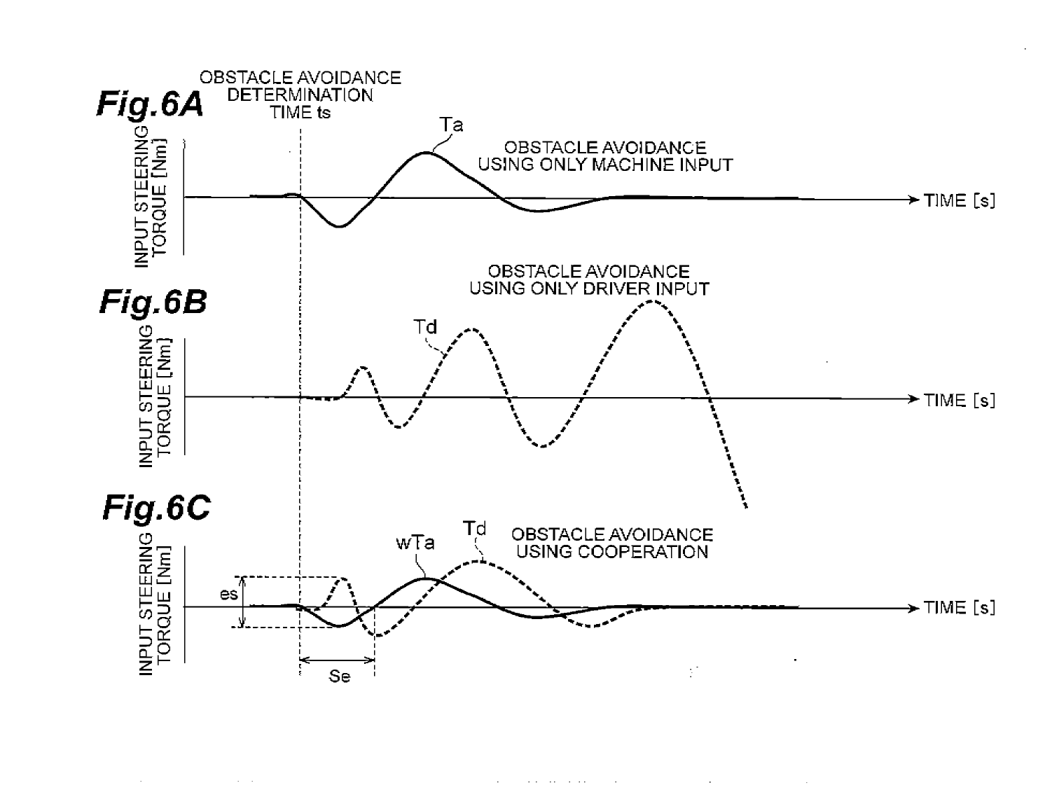

FIG. 6A is a graph illustrating input steering torque over time when obstacle avoidance is performed only by a machine input. FIG. 6B is a graph illustrating input steering torque over time when obstacle avoidance is performed only by the input of the driver D. FIG. 6C is a graph illustrating input steering torque over time when obstacle avoidance is performed by the cooperation between the driving operation of the driver D and the driving assist control. In FIGS. 6A to 6C, an obstacle avoidance determination time ts is the time when the driving assist device 1 determines that obstacle avoidance is needed.

As illustrated in FIG. 6A, when obstacle avoidance is performed by the automatic steering of the driving assist device 1, without the driving operation of the driver D, that is, traveling control is mainly performed by the device, it is easy to stabilize the posture of the vehicle after the obstacle avoidance. However, there is a concern that the driver D feels discomfort according to circumstances. As illustrated in FIG. 6B, when obstacle avoidance is performed only by the input of the driving operation by the driver D, input steering torque diverges and it is difficult to stabilize the posture of the vehicle in a short time. In contrast, for example, as illustrated in FIG. 6C, the driving assist device 1 limits the amount of driving assist control for the vehicle M according to the driving skill of the driver D and reflects the driving operation amount of the driver D in traveling control for the vehicle M. Therefore, it is possible to perform driving assist control which cooperates with the driving operation of the driver D. When the driving operation of the driver D is detected during driving assist control, the driving assist device 1 reflects the driving operation amount of the driver D in traveling control for the vehicle M. Therefore, the driver D can mainly drive the vehicle M and obtain the feeling of driving the vehicle M. As a result, it is possible to reduce the discomfort of the driver for driving assist control.

According to the driving assist device 1, limitations on the amount of driving assist control vary depending on the driving skill of the driver D. Therefore, the driver D can receive an assist corresponding to the driving skill and it is possible to prevent the driver D from feeling discomfort with driving assist control. In addition, the driving assist device 1 increases limitations on the amount of driving assist control as the driving skill is improved. Therefore, the driver D can feel an improvement in the driving skill in the form of a reduction in the amount of driving assist control and can obtain the feeling of fulfilling from improvement in driving skill.

According to the driving assist device 1, it is possible to easily evaluate the driving skill of the driver D, using the comparison between the history of the driving operation of the driver D in the traveling section, such as a curve section, and the reference driving operation corresponding to the shape of the road in the traveling section.

[Adjustment of Weight Coefficient w According to Driver]

Next, the adjustment of the weight coefficient w according to the driver D will be described with reference to FIG. 6C. In FIG. 6C, “Se” indicates an initial input time and “es” indicates the difference between the limited machine input steering torque wTa and the driver input steering torque Td for the initial input time Se. The initial input time Se is the time required for detecting the response of the driving operation of the driver D to the driving assist control after the driving assist control starts. For example, the initial input time Se can be a time of 1 second after the start of the driving assist control, considering the dead time of the driver D.

The weight coefficient calculation unit 25 adjusts the weight coefficient w on the basis of the response of the driving operation of the driver D to the driving assist control. It was newly found that the response of the driving operation of the driver D to the driving assist control was likely to be made immediately after the driving assist control started. The weight coefficient calculation unit 25 adjusts the weight coefficient w on the basis of the difference es between the limited machine input steering torque wTa and the driver input steering torque Td for the initial input time Se. For example, the maximum value of the difference between the limited machine input steering torque wTa and the driver input steering torque Td for the initial input time Se may be used as the difference es. In addition, a phase difference (time lag) between the limited machine input steering torque wTa and the driver input steering torque Td may be used as the difference es. When the difference es between the limited machine input steering torque wTa and the driver input steering torque Td is large, it is considered that the driver D feels discomfort due to the driving assist control and strongly holds the steering wheel. When the difference es between the limited machine input steering torque wTa and the driver input steering torque Td is small, there is a high possibility that the driver D will not feel discomfort due to the driving assist control.

When the difference es between the limited machine input steering torque wTa and the driver input steering torque Td is greater than a predetermined determination threshold value, the weight coefficient calculation unit 25 adjusts the weight coefficient w to a small value. For example, the weight coefficient calculation unit 25 adjusts the weight coefficient w such that the weight coefficient w decreases as the difference es increases.

The weight coefficient calculation unit 25 does not adjust the weight coefficient w on the basis of the difference es, but may adjust the weight coefficient w on the basis of the degree of identity between the limited machine input steering torque wTa and the driver input steering torque Td for the initial input time Se. The weight coefficient calculation unit 25 may adjust the weight coefficient w, using a coherence evaluation function which is a function of the magnitudes of the limited machine input steering torque wTa and the driver input steering torque Td for the initial input time Se and the degree of identity between the phases of the torque. For example, a function in which a weight for each driving scene is added to the phase difference between the limited machine input amount and the driving operation amount of the driver D may be used as the coherence evaluation function.

As described above, the driving assist device 1 adjusts the weight coefficient w according to the driver D. Therefore, it is possible to prevent driving assist control which is not suitable for the intention of the driver D. In addition, the weight coefficient w is not necessarily adjusted.

[Modification of Control Related to Calculation of Weight Coefficient w]

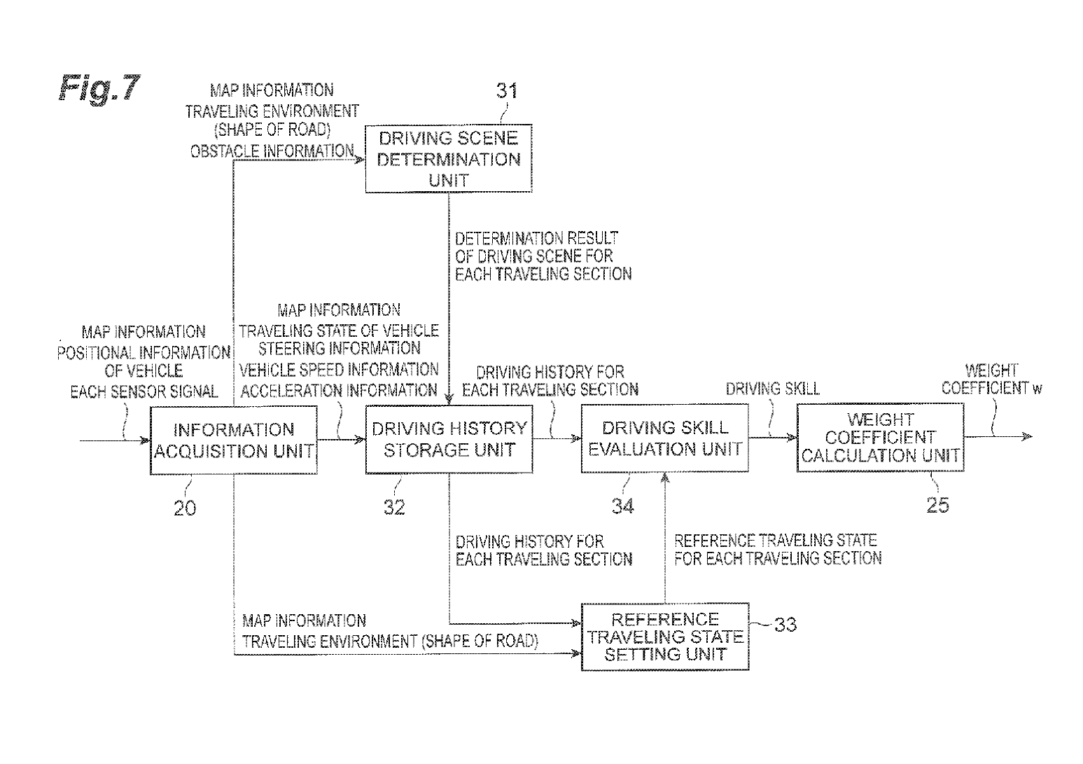

Next, a modification of the control related to the calculation of the weight coefficient w will be described. FIG. 7 is a block diagram illustrating a modification of the control related to the calculation of the weight coefficient w. The modification illustrated in FIG. 7 differs from the first embodiment in the functions of a driving scene determination unit 31, a driving history storage unit 32, a reference traveling state setting unit 33, and a driving skill evaluation unit 34. In the modification, the driving skill of the driver D is not evaluated by the comparison between the driving operation of the driver D and the reference driving operation, but is evaluated by the comparison between the traveling state of the vehicle M corresponding to the driving operation of the driver D and the reference traveling state. The reference traveling state is a traveling state which is a standard for evaluating the driving skill of the driver D. The reference traveling state includes at least one of a steering state as a reference (a reference steering state: the state of the tire angle of the vehicle M), a vehicle speed state as a reference (a reference vehicle speed state), and an acceleration and deceleration state as a reference (reference acceleration and deceleration state).

Similarly to the first embodiment, the driving scene determination unit 31 sets the traveling section to the road on which the vehicle M has traveled and determines whether the driving scene of the vehicle M in the traveling section is the normal scene. When it is determined that the driving scene of the vehicle M in the traveling section is the normal scene, the driving scene determination unit 31 determines whether the vehicle M has been driven in the traveling section by the driving operation of the driver D. For example, when the vehicle M has been driven in the traveling section by the lane keeping assist, the driving scene determination unit 31 determines that the vehicle M has not been driven in the traveling section by the driving operation of the driver D. For example, when the vehicle M has been driven in the traveling section only by the driving operation of the driver D, without using the driving assist control, the driving scene determination unit 31 determines that the vehicle M has been driven in the traveling section by the driving operation of the driver D. When only the driving assist control which has a small effect on the traveling state of the vehicle M has been used, the driving scene determination unit 31 may determine that the vehicle M has been driven in the traveling section by the driving operation of the driver D.

The driving history storage unit 32 records the driving history of the vehicle M. The driving history includes the history of the traveling state of the vehicle M (for example, a steering state, a vehicle speed state, and an acceleration and deceleration state), in addition to the driving operation of the driver D. The driving history storage unit 32 stores the driving history of the traveling section, in which the vehicle M has been determined to be driven only by the driving operation of the driver D by the driving scene determination unit 31, as a driving history for evaluating the driving skill.

The reference traveling state setting unit 33 sets the reference traveling state according to the shape of the road in the traveling section. For example, the reference traveling state setting unit 33 sets, as the reference traveling state, a reference vehicle model which is stored in advance according to the shape of the road in the traveling section. For example, the reference vehicle model which is stored in advance is obtained by statistically modeling (for example, averaging) information about the traveling state of the vehicle M of an experienced driver which is obtained from a plurality of vehicles M. The reference vehicle model is determined according to, for example, the shape of the road in the traveling section. In addition, a reference vehicle model obtained by statistically modeling information about the acquired traveling states of the vehicles M of a plurality of drivers D, without distinguishing experienced drivers, may be used.

Alternatively, the reference traveling state setting unit 33 may set the reference traveling state which is calculated on the basis of the shape of the road in the traveling section to the traveling section. The reference traveling state setting unit 33 may calculate a target path along which the vehicle will travel on the basis of, for example, the shape of the road in the traveling section and may set the traveling state of the vehicle M along the target path as the reference steering state. Similarly, the reference traveling state setting unit 33 may calculate the target speed pattern of the vehicle M on the basis of, for example, the shape of the road in the traveling section and may set the speed state of the vehicle M according to the target speed pattern as the reference vehicle speed state. Similarly, the reference traveling state setting unit 33 may calculate the target acceleration pattern of the vehicle M on the basis of, for example, the shape of the road in the traveling section and may set the acceleration and deceleration state of the vehicle M according to the target acceleration pattern as the reference acceleration and deceleration state.

The driving skill evaluation unit 34 evaluates the driving skill of the driver D on the basis of the driving history for evaluating the driving skill which is stored in the driving history storage unit 32. For example, the driving skill evaluation unit 34 compares the driving history (including the history of the traveling state) of the vehicle M in the traveling section with the reference traveling state in the traveling section to evaluate the driving skill of the driver D.

The driving skill evaluation unit 34 evaluates the driving skill of the driver D on the basis of, for example, the steering state (the state of a change in the tire angle) of the vehicle M in the traveling section and the reference steering state in the traveling section which is set by the reference traveling state setting unit 33. The driving skill evaluation unit 34 may evaluate the driving skill of the driver D on the basis of the difference between the amount of steering in the steering state of the vehicle M and the amount of steering in the reference steering state. The driving skill evaluation unit 34 evaluates that the driving skill of the driver D decreases as the difference between the amount of steering of the vehicle M and the amount of steering in the reference steering state increases. The driving skill evaluation unit 34 evaluates that the driving skill of the driver D increases as the difference between the amount of steering of the vehicle M and the amount of steering in the reference steering state decreases. In addition, the driving skill evaluation unit 34 may evaluate the driving skill of the driver D on the basis of the delay of a change in the amount of steering of the driver D over time with respect to a change in the amount of steering in the reference steering state over time.

The driving skill evaluation unit 34 may evaluate the driving skill of the driver D on the basis of the speed state of the vehicle M in the traveling section and the reference vehicle speed state in the traveling section. The driving skill evaluation unit 34 evaluates the driving skill of the driver D on the basis of, for example, the difference between the speed state of the vehicle M and the reference vehicle speed state. The driving skill evaluation unit 34 may evaluate the driving skill of the driver D on the basis of the delay of a change in the speed state of the vehicle M over time with respect to a change in the reference vehicle speed state over time.

Similarly, the driving skill evaluation unit 34 may evaluate the driving skill of the driver D on the basis of the acceleration and deceleration state of the vehicle M in the traveling section and the reference acceleration and deceleration state in the traveling section. The driving skill evaluation unit 34 evaluates the driving skill of the driver D on the basis of, for example, the difference between the acceleration and deceleration state of the vehicle M and the reference acceleration and deceleration state. The driving skill evaluation unit 34 may evaluate the driving skill of the driver D on the basis of the delay of a change in the acceleration and deceleration state of the vehicle M over time with respect to a change in the reference acceleration and deceleration state over time.

In the above-described modification, it is also possible to appropriately evaluate the driving skill of the driver D.

[Example of Calculation of Target Traveling State and Machine Input Amount]

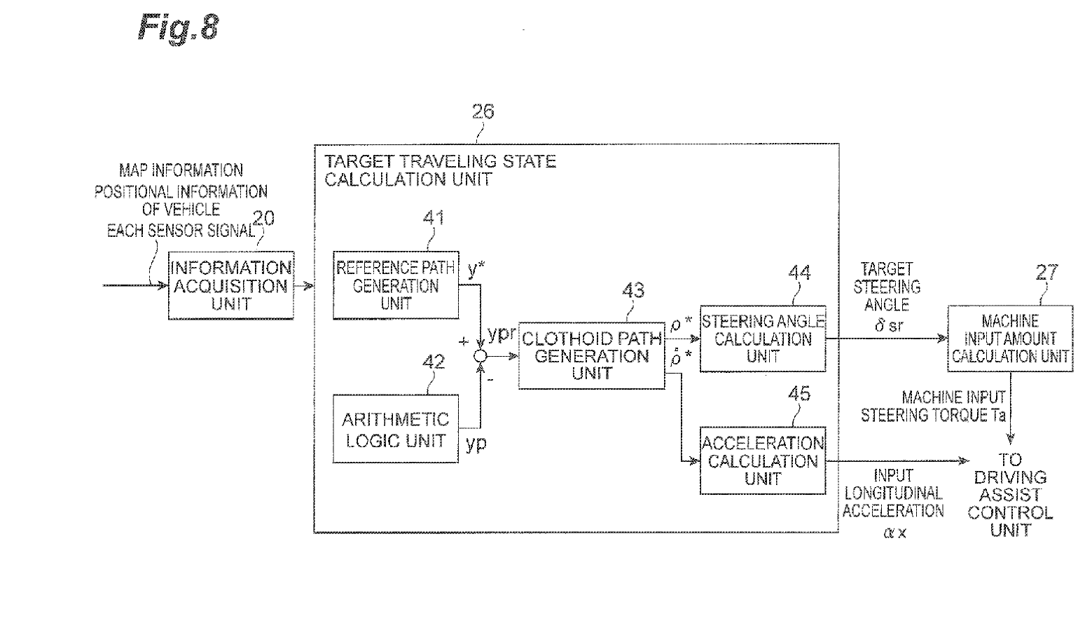

Next, an example of the calculation of the target traveling state and the machine input amount will be described with reference to FIG. 8. FIG. 8 is a block diagram illustrating an example of the calculation of the target traveling state and the machine input amount. Here, the calculation of the target traveling state and the machine input amount in the steering assist control when the vehicle travels around a curve will be described. The target traveling state calculation unit 26 includes a reference path generation unit 41, an arithmetic logic unit 42, a clothoid path generation unit 43, a steering angle calculation unit 44, and an acceleration calculation unit 45.

The reference path generation unit 41 generates an arc-shaped reference path y* related to a curve in front of the vehicle M to be subjected to the driving assist control. For example, the reference path generation unit 41 generates the arc-shaped reference path y* on the basis of the map information and the positional information of the vehicle M acquired by the information acquisition unit 20.

The arithmetic logic unit 42 calculates “yp” represented by the following Expression (1):

### [Expression 1]

In Expression (1), t is time, and yc(t) is the lateral displacement of the vehicle M. In addition, Tp is a predetermined value and corresponds to the time for which the vehicle M is present on the arc-shaped reference path y* in a clothoid curve generated by the clothoid path generation unit 43 which will be described below.

The clothoid path generation unit 43 generates the clothoid curve on the basis of the arc-shaped reference path y* generated by the reference path generation unit 41 and yp generated by the arithmetic logic unit 42. The clothoid path generation unit 43 generates the clothoid curve in which the vehicle M is present on the arc-shaped reference path y* after Tp seconds from the current time. Specifically, the clothoid path generation unit 43 calculates the rate of change (differential value) of a clothoid curve radius ρ*(t) with respect to time using the following Expression (2):

### [Expression 2]

Hereinafter, a dot symbol which is added to the upper part of a reference sign in an expression indicates a differential value. In Expression (2), V(t) is the speed of the vehicle M. The clothoid path generation unit 43 calculates a clothoid curve radius ρ*(t) from the rate of change of the clothoid curve radius ρ*(t) with respect to time.

The steering angle calculation unit 44 calculates a target steering angle δ*sw(t) which is the target traveling state of the driving assist control, on the basis of the clothoid curve radius ρ*(t) calculated by the clothoid path generation unit 43. The steering angle calculation unit 44 calculates the target steering angle δ*sw(t) using the following Expression (3):

### [Expression 3]

In Expression (3), n is a steering gear ratio, Kst is a stability factor, and l is a wheelbase.

The acceleration calculation unit 45 calculates an input longitudinal acceleration αx(t), which is an input amount in driving assist control, on the basis of the rate of change of the clothoid curve radius ρ*(t) calculated by the clothoid path generation unit 43 with respect to time. The acceleration calculation unit 45 calculates the input longitudinal acceleration αx(t) for acceleration control connected with a lateral motion, using the rate of change of the clothoid curve radius ρ*(t) with respect to time which is calculated by a steering control law. The acceleration calculation unit 45 calculates the input longitudinal acceleration αx(t) using the following Expression (4):

### [Expression 4]

In Expression (4), Ka2 is an acceleration gain.

The acceleration calculation unit 45 inputs the calculated input longitudinal acceleration αx(t) to the driving assist control unit 28, without passing through the machine input amount calculation unit 27. The driving assist control unit 28 reflects the input longitudinal acceleration αx(t) in traveling control for the vehicle M. As such, the target traveling state calculation unit 26 may directly calculate a value which is an input amount in the driving assist control.

The machine input amount calculation unit 27 calculates the machine input steering torque Ta on the basis of the target steering angle δ*sw(t) calculated by the steering angle calculation unit 44. The machine input amount calculation unit 27 calculates the machine input steering torque Ta, using the following Expression (5) considering a tire self aligning torque:

### [Expression 5]

In Expression (5), ζ is a caster trail, Kf is the cornering power of the front tire, and lf is a distance between the front axle of the vehicle M and the center of gravity of the vehicle M. The machine input amount calculation unit 27 inputs the calculated machine input steering torque Ta to the driving assist control unit 28.

### Second Embodiment

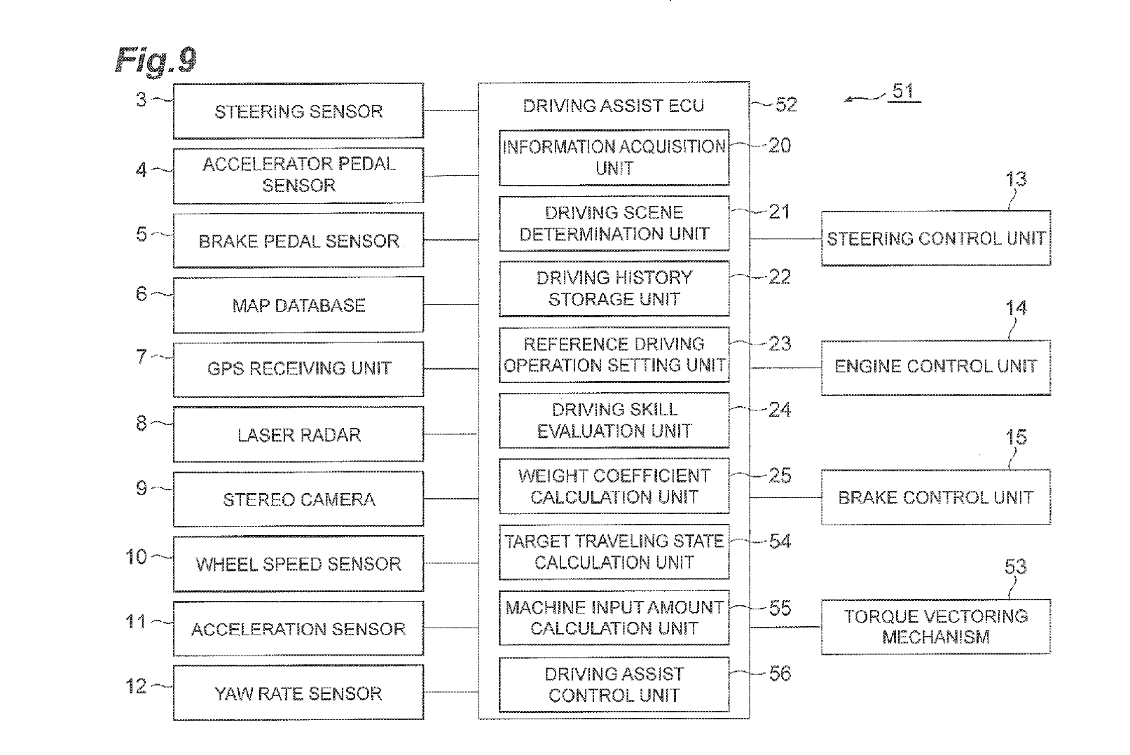

Next, a driving assist device 51 according to a second embodiment will be described with reference to the drawings. FIG. 9 is a block diagram illustrating the driving assist device 51 according to the second embodiment. The driving assist device 51 illustrated in FIG. 9 mainly differs from the driving assist device according to the first embodiment in that a torque vectoring mechanism 53 is used to perform steering assist control. The torque vectoring mechanism 53 controls the distribution of driving force transmitted to a pair of left and right wheels to generate a yaw rate in a vehicle M. A known structure according to the related art can be used as the torque vectoring mechanism 53. The driving assist device 51 performs steering assist control for the vehicle M, using an assist motor AM which controls the steering torque of the vehicle M and the torque vectoring mechanism 53.

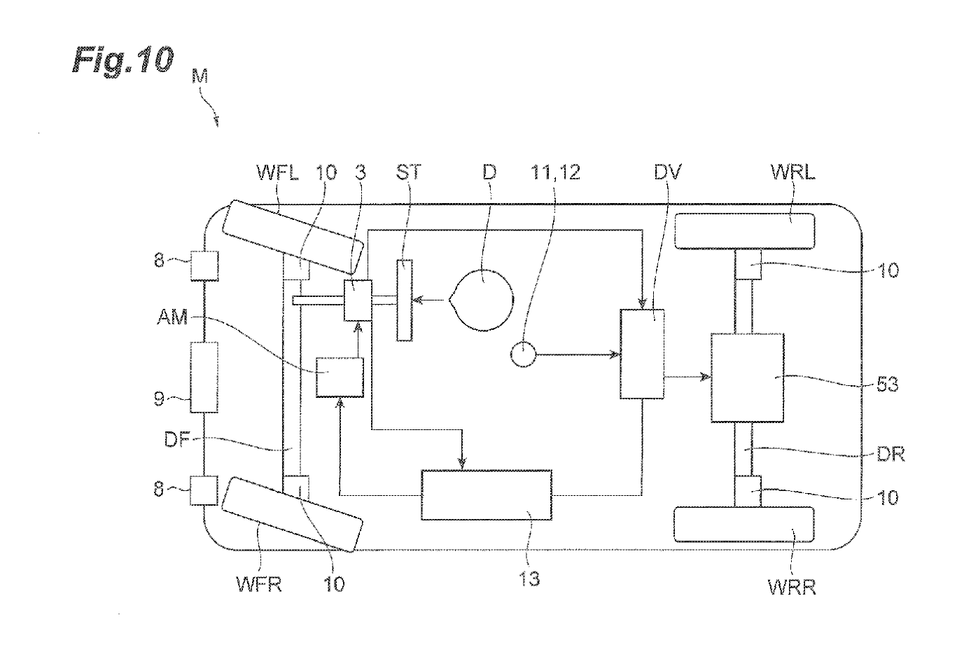

FIG. 10 is a diagram illustrating the structure of the vehicle M including the torque vectoring mechanism. As illustrated in FIG. 10, the vehicle M includes the assist motor AM which controls the steering torque of a steering wheel ST and the torque vectoring mechanism 53 which controls the distribution of the driving force to a pair of left and right wheels WRL and WRR. The torque vectoring mechanism 53 is provided in the rear axle of the vehicle M.

The assist motor AM is controlled by a steering control unit 13. The torque vectoring mechanism 53 is controlled by a distribution calculation unit DV. The distribution calculation unit DV calculates the distribution of the driving force to the wheels WRL and WRR by the torque vectoring mechanism 53. The distribution calculation unit DV forms, for example, a portion of a driving assist ECU 52 and implements a function related to steering assist control among the functions of a target traveling state calculation unit 54, a machine input amount calculation unit 55, and a driving assist control unit 56.

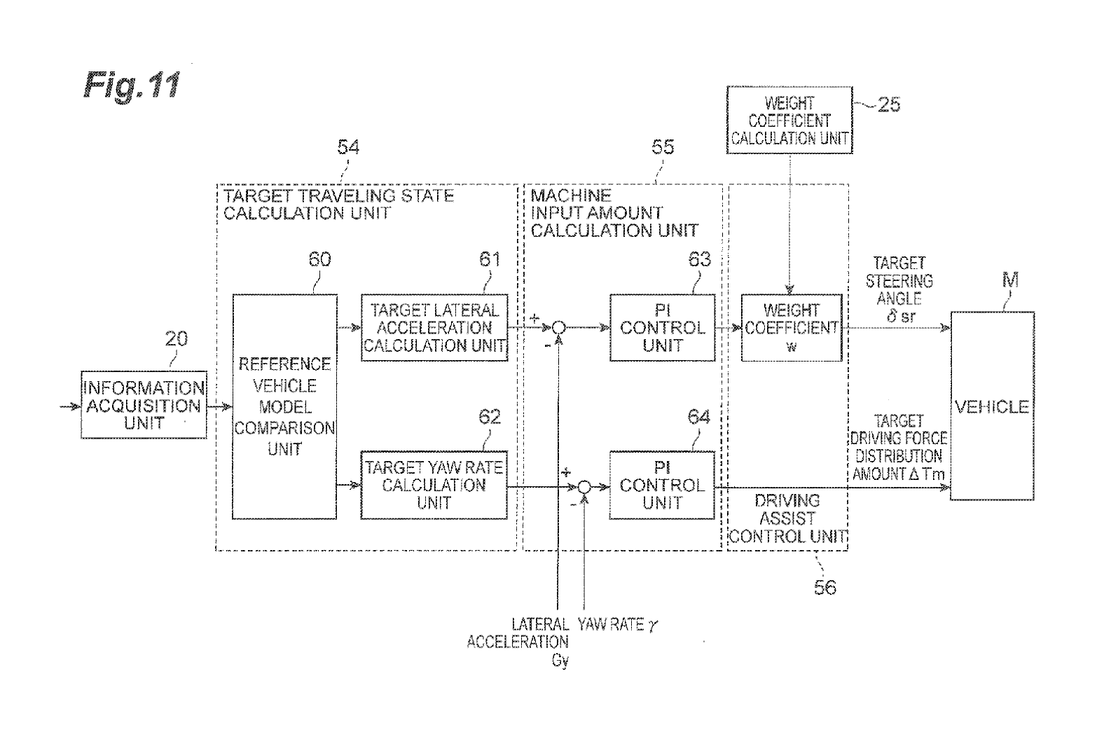

FIG. 11 is a block diagram illustrating control for the torque vectoring mechanism. For example, the distribution calculation unit DV implements the functions of the target traveling state calculation unit 54, the machine input amount calculation unit 55, and the driving assist control unit 56 illustrated in FIG. 11. As illustrated in FIG. 11, the target traveling state calculation unit 54 includes a reference vehicle model comparison unit 60, a target lateral acceleration calculation unit 61, and a target yaw rate calculation unit 62.

The reference vehicle model comparison unit 60 determines the distribution of the assist motor AM and the torque vectoring mechanism 53 in the steering assist control on the basis of the traveling environment of the vehicle M recognized by an information acquisition unit 20, using a reference vehicle model which is stored in advance. For example, a vehicle model which is statistically calculated from information about the traveling states of a plurality of vehicles M can be used as the reference vehicle model which is stored in advance. The target lateral acceleration calculation unit 61 calculates the target lateral acceleration of the vehicle M on the basis of the distribution determined by the reference vehicle model comparison unit 60. The target yaw rate calculation unit 62 calculates the target yaw rate of the vehicle M on the basis of the distribution determined by the reference vehicle model comparison unit 60.

The machine input amount calculation unit 55 includes a PI control unit 63 and a PI control unit 64. The PI control unit 63 and the PI control unit 64 perform proportional integral control using, for example, the following Expression (6):

### [Expression 6]

In Expression (6), u(t) is an output, e(t) a deviation which will be described below, Kp is a proportional gain, Ki is an integral gain, and t is time.

The PI control unit 63 performs the calculation represented by the above-mentioned Expression (6), using the difference between the target lateral acceleration calculated by the target lateral acceleration calculation unit 61 and the current lateral acceleration of the vehicle M as the deviation e(t), and outputs the machine input steering torque Ta as the output u(t) of the above-mentioned Expression (6). The PI control unit 63 outputs the machine input steering torque Ta to the driving assist control unit 56.

The PI control unit 64 performs the calculation represented by the above-mentioned Expression (6), using the difference between the target yaw rate calculated by the target yaw rate calculation unit 62 and the current target yaw rate of the vehicle M as the deviation e(t) and outputs a target driving force distribution amount ΔTm as the output u(t) of the above-mentioned Expression (6). The PI control unit 64 outputs the target driving force distribution amount ΔTm to the driving assist control unit 56.

The driving assist control unit 56 performs steering assist control for the vehicle M on the basis of the machine input steering torque Ta and the target driving force distribution amount ΔTm. FIG. 11 illustrates a case in which a driving operation of a driver D is detected by the information acquisition unit 20 during steering assist control. When the driving operation of the driver D is detected by the information acquisition unit 20 during steering assist control, the driving assist control unit 56 reflects a limited machine input steering torque wTa, which is obtained by multiplying the machine input steering torque Ta by a weight coefficient w, in traveling control for the vehicle M. Although not illustrated in FIG. 11, the driving assist control unit 56 reflects the driver input steering torque Td corresponding to the driving operation amount of the driver D in traveling control for the vehicle M.

The driving assist device 51 according to the second embodiment performs steering assist control for the vehicle M, using the torque vectoring mechanism in addition to the assist motor which controls the steering torque of the vehicle M. Therefore, it is possible to reduce the load of the assist motor AM.

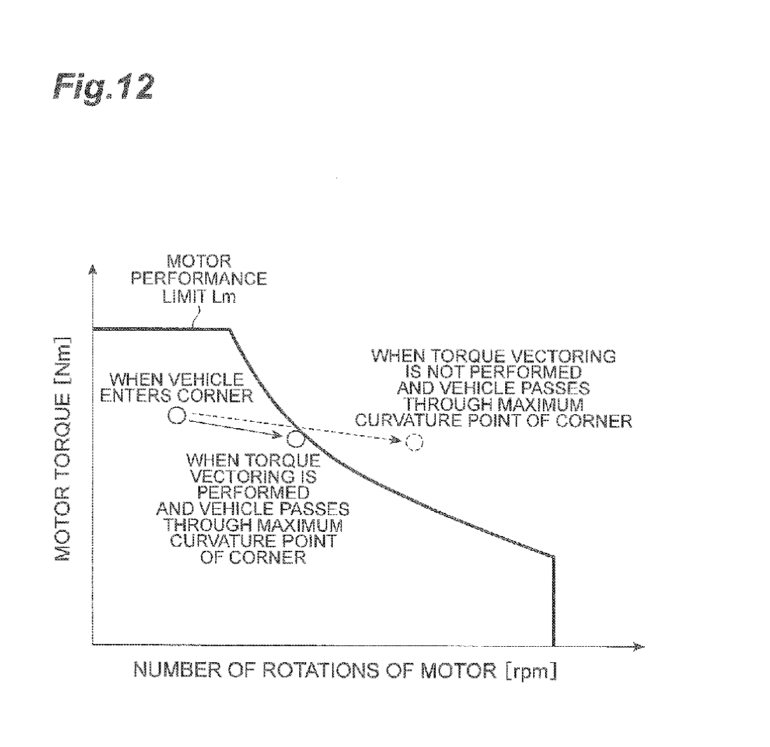

FIG. 12 is a graph illustrating the load of the assist motor. In FIG. 12, the horizontal axis is the torque of the assist motor AM and the horizontal axis is the number of rotations of the assist motor AM. In addition, Lm is the motor performance limit of the assist motor AM. FIG. 12 illustrates a case in which steering assist control is performed for the vehicle M at a corner including a point with a large curvature (maximum curvature point).

As illustrated in FIG. 12, in the case in which the torque vectoring mechanism 53 is not used, when the vehicle M enters the corner and passes through the corner maximum curvature point, the load of the assist motor AM is greater than the motor performance limit Lm. In contrast, the driving assist device 51 performs steering assist control using the torque vectoring mechanism 53. Therefore, when the vehicle passes through the maximum curvature point of the corner, the load of the assist motor AM falls within the motor performance limit Lm. As such, according to the driving assist device 51 of the second embodiment, the torque vectoring mechanism 53 can be used to reduce the load of the assist motor AM in steering assist control.

The preferred embodiments and modifications of the invention have been described above. However, the invention is not limited to the above-described embodiments and modifications. For example, the structures of the embodiments and modifications may be appropriately combined with each other. The second embodiment may use the structures according to the above-described modifications.

What is claimed is:

1. A driving assist device that calculates a target traveling state of a vehicle on the basis of a traveling environment of the vehicle and performs driving assist control for the vehicle such that the traveling state of the vehicle is close to the target traveling state, comprising:
a driving operation detection unit configured to detect a driving operation of a driver for the vehicle;
a driving skill evaluation unit configured to evaluate a driving skill of the driver on the basis of a history of the driving operation of the driver detected by the driving operation detection unit; and
a driving assist control unit configured to perform the driving assist control for the vehicle on the basis of the traveling state of the vehicle and the target traveling state,
wherein, when the driving operation detection unit detects the driving operation of the driver during the driving assist control, the driving assist control unit limits the amount of driving assist control for the vehicle according to the driving skill of the driver evaluated by the driving skill evaluation unit and reflects the driving operation amount of the driver in traveling control for the vehicle.

2. The driving assist device according to claim 1,
wherein the driving skill evaluation unit evaluates the driving skill of the driver on the basis of a history of a steering operation of the driver in a traveling section in which the vehicle has traveled and a reference steering operation corresponding to the shape of a road in the traveling section.

3. The driving assist device according to claim 1,
wherein the driving assist control includes steering assist control for the vehicle, and
the driving assist control unit performs the steering assist control for the vehicle, using an assist motor that controls the steering torque of the vehicle and a torque vectoring mechanism that controls the distribution of a driving force transmitted to a pair of left and right wheels of the vehicle.

4. The driving assist device according to claim 2,
wherein the driving assist control includes steering assist control for the vehicle, and
the driving assist control unit performs the steering assist control for the vehicle, using an assist motor that controls the steering torque of the vehicle and a torque vectoring mechanism that controls the distribution of a driving force transmitted to a pair of left and right wheels of the vehicle.
